(19) United States
(12) Patent Application Publication
(10) Pub. No.: US 2025/0272603 A1
(43) Pub. Date: Aug. 28, 2025

(54) SYSTEM AND METHOD FOR EVALUATING AN UNSUPERVISED CLUSTERING MACHINE LEARNING (ML) MODEL

(71) Applicant: Panasonic Intellectual Property Management Co., Ltd., Osaka (JP)

(72) Inventors: Manish GUPTA, Singapore (SG); Chandra Suwandi WIJAYA, Singapore (SG); Tadhg KENNEDY, Singapore (SG)

(21) Appl. No.: 18/586,106

(22) Filed: Feb. 23, 2024

(51) Int. Cl. G06N 20/00

(52) U.S. Cl. CPC G06N 20/00

(57) ABSTRACT

Disclosed herein is a method for evaluating an unsupervised clustering machine learning (ML) model. The method includes generating a set of model clusters via the unsupervised clustering ML model. Further, the method includes comparing a set of test set clusters and the set of model clusters. Further, the method includes categorizing each of the set of model clusters into an assessment group based on the comparison. The categorized assessment group is at least one of a match group, a correct group, a partial group, and an incorrect group. Furthermore, the method includes assigning a similarity value to each of the set of model clusters based on the categorized assessment group. Furthermore, the method includes determining a total similarity value based on combining the assigned similarity value of each of the set of model clusters, such that the total similarity value indicates evaluation of the unsupervised clustering ML model.

### FIELD OF THE INVENTION

The present invention generally relates to the field of Artificial Intelligence (AI) and Machine Learning (ML), and more specifically relates to a system and method for evaluating an unsupervised clustering ML model.

### BACKGROUND

In recent years, the application of machine learning models has expanded across various fields, including data science, marketing, finance, retail, and more. These machine learning models are developed using machine learning algorithms that learn from data, which can be labeled, unlabeled, or a combination of both. These machine learning algorithms are trained to achieve different objectives, such as classification or prediction modeling.

The latest advancements in machine learning algorithms have seen the rise of unsupervised learning, which is instrumental in extracting valuable insights from data. The unsupervised learning uses the clustering method, which groups unlabeled data based on their similarities or differences. The clustering method is employed to uncover meaningful structures, explanatory underlying processes, generative features, and inherent groupings within a set of examples.

Further, it is crucial to evaluate the performance of an unsupervised clustering Machine Learning (ML) model to assess the quality or accuracy of the clusters it creates. However, measuring the quality or accuracy of the clusters is very difficult especially when features of the data are far less evident. The one of the conventional methods is to manually review the clusters to gauge the quality or accuracy of the clusters, however, the manual method is tedious and time-consuming.

One of the conventional methods is to select the data during a fixed time period and use multiple language models to generate clusters. The method further merges the clusters to optimize the clusters and boost the accuracy. However, the above conventional methods do not disclose how to measure the accuracy of the clusters being generated. It is just assumed that the merged clusters are an improvement.

Therefore, there lies a need for an improved method and system capable of providing a quantitative value for the accuracy of the clusters for evaluating the unsupervised clustering ML model.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

In an embodiment, a method for evaluating an unsupervised clustering machine learning (ML) model is disclosed. The method includes generating a set of model clusters via the unsupervised clustering ML model. The set of model clusters is generated for one set of hyperparameters. Further, the method includes comparing a set of test set clusters and the set of model clusters. Further, the method includes categorizing each of the set of model clusters into an assessment group based on the comparison. The categorized assessment group is at least one of a match group, a correct group, a partial group, and an incorrect group. Furthermore, the method includes assigning a similarity value to each of the set of model clusters based on the categorized assessment group. Furthermore, the method includes determining a total similarity value based on combining the assigned similarity value of each of the set of model clusters, such that the total similarity value indicates evaluation of the unsupervised clustering ML model.

Also disclosed herein is a system for evaluating an unsupervised clustering machine learning (ML) model. The system includes a memory and at least one processor in communication with the memory. The at least one processor is configured to generate a set of model clusters via the unsupervised clustering ML model. Further, the at least one processor is configured to compare a set of test set clusters and the set of model clusters. Further, the at least one processor is configured to categorize each of the set of model clusters into an assessment group based on the comparison. The categorized assessment group is at least one of a match group, a correct group, a partial group, and an incorrect group. Furthermore, the at least one processor is configured to assign a similarity value to each of the set of model clusters based on the categorized assessment group. Furthermore, the at least one processor is configured to determine a total similarity value based on combining the assigned similarity value of each of the set of model clusters, such that the total similarity value indicates evaluation of the unsupervised clustering ML model.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram of a system for evaluating an unsupervised clustering machine learning (ML) model, according to one or more embodiments disclosed herein;

FIG. 2 illustrates an example depicting categorization of each of a set of model clusters and a scoring algorithm to assign a similarity value to each of the set of model clusters, according to one or more embodiments disclosed herein;

FIG. 3 illustrates an example of a sigmoid function used in assigning the similarity value as indicative of a penalized value, according to one or more embodiments disclosed herein;

FIG. 4 illustrates a flow chart of a method for evaluating the unsupervised clustering ML model, according to one or more embodiments disclosed herein;

FIG. 5 illustrates a flow chart of a method for identifying optimal hyperparameters for evaluating the unsupervised clustering ML model, according to one or more embodiments disclosed herein; and

FIG. 6 illustrates an example output with the set of optimal hyperparameters for evaluating the unsupervised clustering ML model, according to one or more embodiments disclosed herein.

Further, skilled artisans will appreciate that those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Embodiments will be described below in detail with reference to the accompanying drawings.

In one or more embodiments of the proposed disclosure, a scoring methodology with penalization scaling based on ground truth cluster size is proposed for evaluating an unsupervised clustering machine learning (ML) model. The proposed scoring methodology generates a unified and standard score regardless of the clustering algorithm used to generate clusters in the unsupervised clustering ML model.

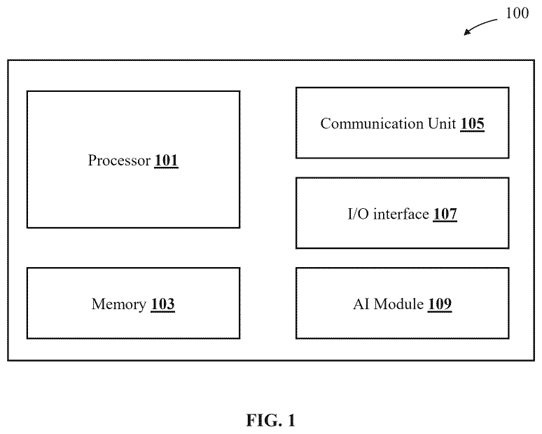

FIG. 1 illustrates a block diagram of a system 100 for evaluating the unsupervised clustering ML model, according to one or more embodiments disclosed herein.

The system 100 includes a processor 101, a memory 103, a communication unit 105, an input/output interface 117, and an Artificial Intelligence (AI) module 109. The system 100 may correspond to one of a server at a user location, a remote server, a user device, or any other electronic device. In one or more embodiments, the system 100 may include a combination of an electronic device and a server.

The processor(s) 101 can be a single processing unit or several units, all of which could include multiple computing units. The processor 101 may be implemented as one or more microprocessors, microcomputers, microcontrollers, digital signal processors, central processing units, state machines, logic circuitries, and/or any devices that manipulate signals based on operational instructions. Among other capabilities, the processor 101 is configured to fetch and execute computer-readable instructions and data stored in the memory 103.

The memory 103 includes one or more computer-readable storage media. The memory 103 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 103 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The communication unit 105 is configured to communicate data or any other signal over a communication network. Further, the communication unit 105 may include a communication port, a communication interface, or a transceiver for sending and receiving signals from the system 100 via the communication network. The communication port or the communication interface may be a part of a processing unit or may be a separate component. The communication port may be created in software or may be a physical connection in hardware. The communication port may be configured to connect with the communication network, external media, the display, or any other components in the system 100, or combinations thereof. The connection with the communication network may be a physical connection, such as a wired Ethernet connection, or may be established wirelessly as discussed above. Likewise, the additional connections with other components of the system 100 may be physical or may be established wirelessly.

The I/O interface 107 refers to hardware or software components that enable communication between the system 100 and any other electronic device. The I/O interface 107 serves as a communication medium for exchanging information, commands, signals, or query responses with other devices or systems. The I/O interface 107 may be a part of the processor 101 or maybe a separate component. The I/O interface 107 may be created in software or maybe a physical connection in hardware. The I/O interface 107 may be configured to connect with an external network, external media, the display, or any other components, or combinations thereof. The external network may be a physical connection, such as a wired Ethernet connection, or may be established wirelessly.

The AI module 109 may include a Machine Learning (ML) model. The ML model is an algorithm that finds patterns or makes decisions from an unseen dataset. The ML model performs the tasks by having it ‘trained’ with a large dataset. The dataset may include labeled, unlabeled, or mixed data. The ML model is trained using machine learning algorithms. Examples of machine learning algorithms include but are not limited to supervised learning, unsupervised learning, semi-supervised learning, or reinforcement learning.

In an embodiment, the AI module 109 may include the unsupervised clustering ML model. The unsupervised clustering ML model uses the unsupervised learning for training. The unsupervised learning uses the clustering algorithms to group an unlabeled dataset into groups that comprise similar characteristics. The types of clustering algorithms in unsupervised machine learning include K-means clustering, hierarchical clustering, Density-Based Spatial Clustering of Applications with Noise (DBSCAN), or a mean-shift clustering algorithm.

In the K-means clustering, the unlabeled dataset is grouped in terms of characteristics and similarities. K is a letter that represents the number of clusters. For example, if K=5, then the number of desired clusters is 5.

In the hierarchical clustering, a hierarchy of clusters is constructed using an algorithm. The algorithm allocates each dataset of the unlabeled dataset to its cluster and the allocation ends if there is only one cluster left.

In DBSCAN, the unlabeled dataset close to each other are grouped. The unlabeled dataset far from each other are termed outliers. The DBSCAN then sorts the grouped dataset based on commonalities.

The mean-shift clustering algorithm is particularly used for handling images and computer vision processing. The mean-shift clustering algorithm also determines the clusters without setting the initial number of clusters. The mean-shift clustering algorithm is a type of the hierarchical clustering and works by iterating over all of the unlabeled dataset and shifting them towards the mode value. The mode value is the high density area of the unlabeled dataset in a region.

In one or more embodiments, one or more functions associated with the unsupervised clustering ML model included in the AI module 109 may be performed through the non-volatile memory, the volatile memory, and the processor 101.

The processor 101 generates a set of model clusters via the unsupervised clustering ML model. The processor 101 may generate the set of model clusters within the unlabeled dataset. The set of model clusters is generated for one set of hyperparameters. The unsupervised clustering ML model may use any clustering algorithm to generate the set of model clusters. The clustering algorithm organizes the unlabeled datasets into groups whose member datasets are similar in some way. These groups are termed as clusters. The datasets in the same cluster have a similar attribute and the datasets in different clusters have a dissimilar attribute. In a non-limiting example, the unsupervised clustering ML model may use one of the K-means clustering, the hierarchical clustering, the DBSCAN, or the mean-shift clustering algorithm.

Further, the processor 101 compares a set of test set clusters and the set of model clusters. The set of test set clusters are the ground truth clusters which are reference sets of clusters used for the clustering process. For instance, the processor 101 may compare one or more model data points within the set of model clusters with one or more test data points within the set of test set clusters.

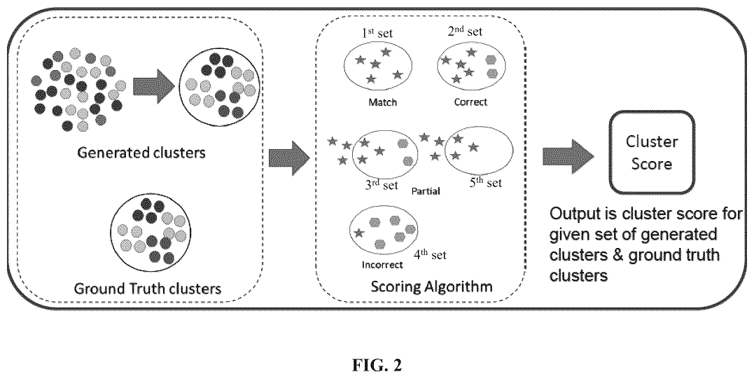

Further, the processor 101 categorizes each of the set of model clusters into an assessment group based on the comparison. The processor 101 may categorize each of the set of model clusters into one of a match group, a correct group, a partial group, and an incorrect group. A detailed explanation of categorizing each of the set of model clusters into the assessment group is provided in forthcoming paragraphs with reference to FIG. 2.

Further, the processor 101 assigns a similarity value to each of the set of model clusters based on the categorized assessment group. For example, the processor 101 may assign the similarity value indicative of a non-zero integer to each of the set of model clusters categorized into the match group. In another example, the processor 101 may assign the similarity value indicative of a penalized value to each of the set of model clusters categorized into the correct group. In another example, the processor 101 may assign the similarity value indicative of a non-zero integer to each of the set of model clusters categorized into the partial group. In another example, the processor 101 may assign the similarity value indicative of a zero value to the set of model clusters categorized into the incorrect group.

Further, the processor 101 determines a total similarity value by combining the assigned similarity value of each of the set of model clusters. In one or more embodiments, the total similarity value may indicate the quality or accuracy of the unsupervised clustering ML model. The total similarity value may refer to the one set of hyperparameters for any clustering algorithms in unsupervised machine learning.

FIG. 2 illustrates an example depicting categorization of each of the set of model clusters and the scoring algorithm to assign the similarity value to each of the set of model clusters, according to one or more embodiments disclosed herein.

In one or more embodiments, for categorizing each of the set of model clusters into the assessment group, first, the processor 101 generates the set of model clusters (generated clusters). For example, five sets of generated model clusters are shown in FIG. 2.

Then, the processor 101 compares the one or more model data points within the set of model clusters (generated clusters) with the one or more test data points within the set of test set clusters (ground truth clusters).

The processor 101 may categorize the first set of the generated model clusters into the match group if each of the one or more model data points in the first set of the generated model clusters completely matches the one or more test data points. For example, if the set of test set clusters is given as [1, 2, 3] and the first set of the generated model clusters is given as [2, 1, 3]. In this, each of the one or more model data points in the first set of the generated model clusters [2, 1, 3] completely matches with the one or more test data points [1, 2, 3]. Thus, the first set of the generated model clusters is categorized into the match group.

The processor 101 may categorize the second set of the generated model clusters into the correct group if the one or more model data points in the second set of the generated model clusters completely match the one or more test data points, and the one or more model data points in the second set of the generated model clusters includes at least one additional model data point different from the one or more test data points. For example, if the set of test set clusters is given as [1, 2, 3] and the second set of the generated model clusters is given as [2, 1, 3, 4]. In this the one or more model data points in the second set of the generated model clusters [2, 1, 3] completely match with the one or more test data points [1, 2, 3], and the one or more model data points in the second set of the generated model clusters includes additional data [4] different from the one or more test data points. Thus, the second set of the generated model clusters is categorized into the correct group.

The processor 101 may categorize the third set of the generated model clusters into the partial group if a portion of the one or more model data points in the third set of the generated model clusters completely matches the one or more test data points, and the third set of the generated model clusters has at least one additional model data point different from the one or more test data points. For example, if the set of test set clusters is given as [1, 2, 3] and the third set of the generated model clusters is given as [5, 1, 3]. In this, the portion of the one or more model data points in the third set of the generated model clusters [1, 3] completely matches with the one or more test data points [1, 2, 3], and the third set of the generated model clusters includes additional data [5] different from the one or more test data points. Thus, the third set of the generated model clusters is categorized into the partial group.

The processor 101 may categorize the fourth set of the generated model clusters into the incorrect group the one or more model data points in the fourth set of the generated model clusters are different from the one or more test data points, and a number of different one or more model data points is more than a number of matching one or more model data points. For example, if the set of test set clusters is given as [1, 2, 3] and the fourth set of the generated model clusters is given as [5, 6, 7, 8, 1]. In this the one or more model data points in the fourth set of the generated model clusters [5, 6, 7, 8] are different from the one or more test data points [1, 2, 3], and a number of different one or more model data points (four) is more than a number of matching one or more model data points (one). Thus, the fourth set of the generated model clusters is categorized into the incorrect group.

Further, the processor 101 assigns a similarity value to each of the set of model clusters based on the categorized assessment group. The processor 101 may assign the similarity value equal to 1 to the first set of model clusters which is categorized into the match group. Further, the processor 101 may assign the similarity value indicative of a penalized value to the second set of model clusters which is categorized into the correct group. Further, the processor 101 may assign the similarity value which is a partial value to the third set of model clusters categorized into the partial group. The partial value is a fraction of the one or more test data points present in the one or more test data points. Further, the processor 101 may assign the similarity value equal to zero value to the fourth set of model clusters categorized into the incorrect group.

Further, the processor 101 may determine the total similarity value by combining the assigned similarity value of each of the set of model clusters. The processor 101 may also output the total similarity value as a cluster score for the set of the generated model clusters.

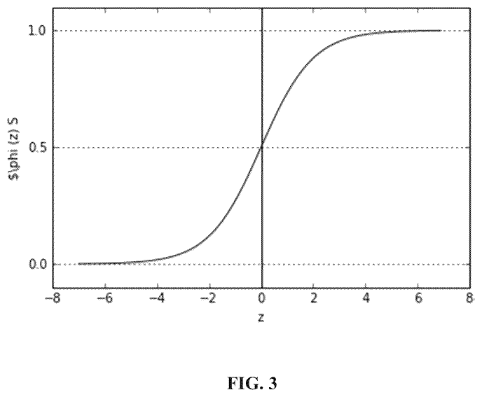

FIG. 3 illustrates an example of a sigmoid function used in assigning the similarity value as indicative of the penalized value, according to one or more embodiments disclosed herein.

Initially, without penalized value the “correct” clusters category does not consider the size of the one or more test data points within the set of test set clusters, which meant that more incorrect articles would penalize the same for the set of test set clusters of 4 or 12. For example, A cluster of 4 test data points with 3 incorrect model data points would be penalized the same as a cluster of 12 test data points with 3 incorrect model data points even though it's representatively a much smaller portion of incorrect articles.

In the proposed method, the processor 101 scales the penalty with the size of the set of test set clusters using the sigmoid function. For example, for the cluster of 4 test data points with 3 incorrect model data points, the penalized value is calculated as (1−exp(3−4))=0.7310585786300049. Further, for the cluster of 12 test data points with 3 incorrect model data points, the penalized value is calculated as (1−exp(3−4))=0.9998766054240138.

Therefore, the algorithm for assigning the similarity value as indicative of the penalized value considers the size of the one or more test data points within the set of test set clusters while penalizing incorrectly included items in a cluster category for the correct group.

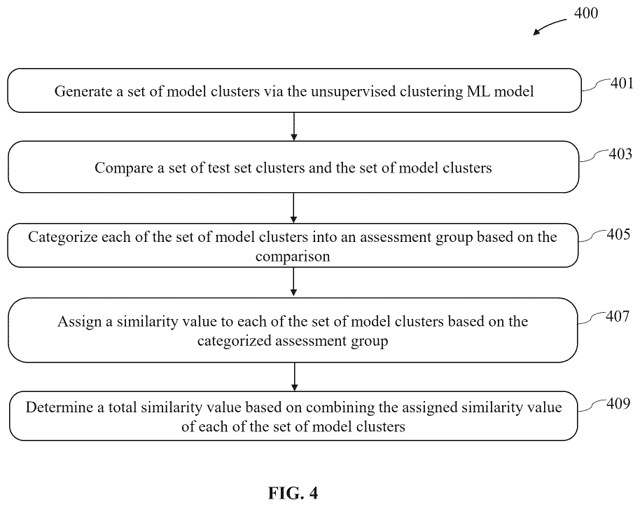

FIG. 4 illustrates a flow chart of a method 400 for evaluating the unsupervised clustering ML model, according to one or more embodiments disclosed herein. The method 400 includes a series of operations steps 401 through 409 performed by the processor 101.

At step 401, the processor 101 generates the set of model clusters via the unsupervised clustering ML model. The processor 101 may generate the set of model clusters within the unlabeled dataset. The flow of the method 400 now proceeds to step 403.

At step 403, the processor 101 compares the set of test set clusters and the set of model clusters. The set of test set clusters are the ground truth clusters which are reference sets of clusters used for the clustering process. For instance, the processor 101 may compare the one or more model data points within the set of model clusters with the one or more test data points within the set of test set clusters. The flow of the method 400 now proceeds to step 405.

At step 405, the processor 101 categorizes each of the set of model clusters into the assessment group based on the comparison. The categorized assessment group is at least one of a match group, a correct group, a partial group, and an incorrect group. The flow of the method 400 now proceeds to step 407.

At step 407, the processor 101 assigns the similarity value to each of the set of model clusters based on the categorized assessment group. For instance, when the assessment group is the match group, the processor 101 determines the similarity between the one or more model data points within the set of model clusters and the one or more test data points within the set of test set clusters. Further, the processor 101 assigns the similarity value indicative of the non-zero integer to the match group, such that the match group indicates that each of the one or more model data points completely matches the one or more test data points.

Further, when the assessment group is the correct group, the processor 101 determines the similarity between the one or more model data points within the set of model clusters and the one or more test data points within the set of test set clusters. Further, the processor 101 assigns the similarity value indicative of the penalized value to the correct group, such that the correct group indicates that the one or more model data points completely match the one or more test data points, and the one or more model data points includes at least one additional model data point different from the one or more test data points.

Further, when the assessment group is the partial group, the processor 101 determines the similarity between the one or more model data points within the set of model clusters and the one or more test data points within the set of test set clusters. Further, the processor 101 assigns the similarity value indicative of the non-zero integer to the partial group, such that the partial group indicates that the portion of the one or more model data points completely matches the one or more test data points and has the at least one additional model data point different from the one or more test data points.

Further, when the assessment group is the incorrect group, the processor 101 determines the similarity between the one or more model data points within the set of model clusters and the one or more test data points within the set of test set clusters. Further, the processor 101 assigns the similarity value indicative of the zero value to the incorrect group, such that the incorrect group indicates that the one or more model data points are different from the one or more test data points, and the number of different one or more model data points is more than the number of matching one or more model data points. The flow of the method 400 now proceeds to step 409.

At step 409, the processor 101 determines the total similarity value by combining the assigned similarity value of each of the set of model clusters. In one or more embodiments, the total similarity value may indicate the quality or the accuracy of the unsupervised clustering ML model.

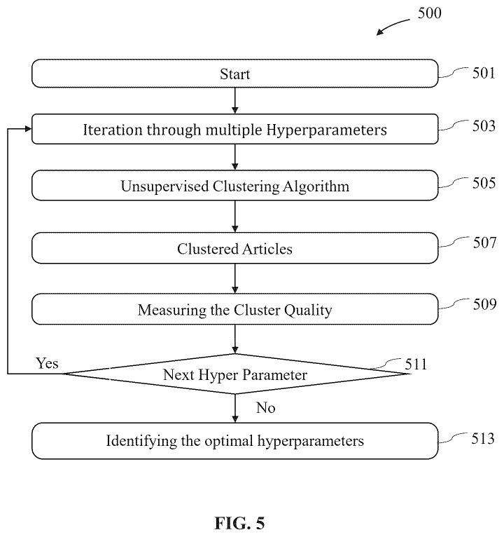

FIG. 5 illustrates a flow chart of a method for identifying optimal hyperparameters for evaluating the unsupervised clustering ML model, according to one or more embodiments disclosed herein. The method 500 includes a series of operations steps 501 through 513 performed by the processor 101.

At step 501, prior to generating the set of model clusters via the unsupervised clustering ML model, a set of hyperparameters is assigned to the unsupervised clustering ML model. For instance, the set of hyperparameters may include a number of branches on a regression tree, a learning rate, and a number of clusters in a clustering algorithm. For example, cluster size ranges from 10 to 100 are assigned as the set of hyperparameters. The flow of the method 500 now proceeds to step 503.

At step 503, the processor 101 iterates through multiple hyperparameters one by one. The processor may perform steps 505 through step 509 for each set of hyperparameters.

At step 505, the processor 101 generates the set of model clusters via the unsupervised clustering ML model. The flow of the method 500 now proceeds to step 507.

At step 507, the processor 101 categorizes each of the set of model clusters into the assessment group based on the comparison of the set of test set clusters and the set of model clusters. The processor then assigns the similarity value to each of the set of model clusters based on the categorized assessment group. The flow of the method 500 now proceeds to step 509.

At step 509, the processor 101 measures the quality of the set of model clusters by determining the total similarity value by combining the assigned similarity value of each of the set of model clusters. The flow of the method 500 now proceeds to step 511.

At step 511, the processor 101 determines whether the total similarity value corresponding to each set of hyperparameters is determined. If it is determined that the total similarity value corresponding to each set of hyperparameters is determined, the flow of the method 500 proceeds to step 513. Further, if it is determined that the total similarity value corresponding to each set of hyperparameters is not determined, the flow of the method 500 goes to step 503.

At step 513, the processor 101 selects the optimal hyperparameters based on the determined similarity value for each set of hyperparameters. For instance, the processor may select a set of optimal hyperparameters by comparing the determined similarity value for each set of hyperparameters and a pre-defined threshold.

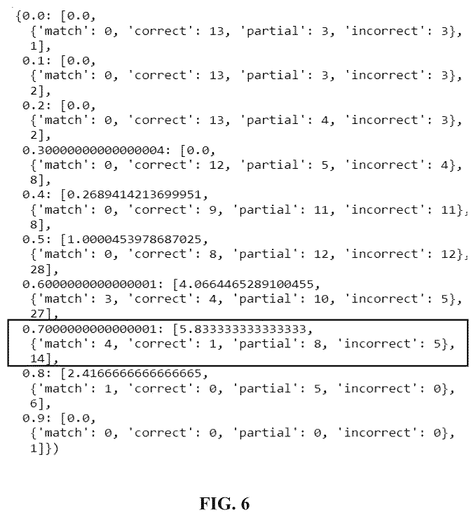

FIG. 6 illustrates an example output with the set of optimal hyperparameters for evaluating the unsupervised clustering ML model, according to one or more embodiments disclosed herein.

As shown in FIG. 6 the best clustering output is shown with the identified optimal hyperparameters. The different output value is obtained with different sets of hyperparameters as we iterate over the set of hyperparameters. The output shows the optimal hyperparameter value, the score, a breakdown of the categories, and the total number of clusters identified.

In an example, the module(s) and/or the unit(s) and/or model(s) may include a program, a subroutine, a portion of a program, a software component, or a hardware component capable of performing a stated task or function. As used herein, the module(s) and/or the unit(s) and/or model(s) may be implemented on a hardware component such as a server independently of other modules, or a module can exist with other modules on the same server, or within the same program. The module(s) and/or unit(s) and/or model(s) may be implemented on a hardware component such as processor one or more microprocessors, microcomputers, microcontrollers, digital signal processors, central processing units, state machines, logic circuitries, and/or any devices that manipulate signals based on operational instructions. The module(s) and/or unit(s) and/or model(s), when executed by the processor(s), may be configured to perform any of the described functionalities.

The method disclosed herein in one or more embodiments provides various technical benefits and advantages. The disclosed scoring methodology provides a quantified value of the accuracy of the clusters from an unsupervised clustering algorithm based on several different cluster categories. It allows to generation of the score irrespective of the clustering algorithm used to generate the clusters. Further, the proposed method allows for quick testing of multiple hyperparameters during development and identification of the best hyperparameter ranges using a small amount of labeled data, thus allowing to save development time and resources.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method for evaluating an unsupervised clustering machine learning (ML) model, the method comprising:
generating a set of model clusters via the unsupervised clustering ML model;
comparing a set of test set clusters and the set of model clusters;
categorizing each of the set of model clusters into an assessment group based on the comparison, wherein the categorized assessment group is at least one of a match group, a correct group, a partial group, and an incorrect group;
assigning a similarity value to each of the set of model clusters based on the categorized assessment group; and
determining a total similarity value based on combining the assigned similarity value of each of the set of model clusters, such that the total similarity value indicates evaluation of the unsupervised clustering ML model.

2. The method as claimed in claim 1, wherein when the assessment group is the match group, the method comprises:
determining similarity between one or more model data points within the set of model clusters and one or more test data points within the set of test set clusters; and
assigning the similarity value indicative of a non-zero integer to the match group, such that the match group indicates that each of the one or more model data points completely matches the one or more test data points.

3. The method as claimed in claim 1, wherein when the assessment group is the correct group, the method comprises:
determining similarity between one or more model data points within the set of model clusters and one or more test data points within the set of test set clusters; and
assigning the similarity value indicative of a penalized value to the correct group, such that the correct group indicates that the one or more model data points completely match the one or more test data points and the one or more model data points include at least one additional model data point different from the one or more test data points.

4. The method as claimed in claim 3, wherein the penalized value indicates a sigmoid function which is scaled based on a number of one or more test data points.

5. The method as claimed in claim 1, wherein when the assessment group is the partial group, the method comprises:
determining similarity between one or more model data points within the set of model clusters and one or more test data points within the set of test set clusters; and
assigning the similarity value indicative of a non-zero integer to the partial group, such that the partial group indicates that a portion of the one or more model data points completely matches the one or more test data points and has at least one additional model data point different from the one or more test data points.

6. The method as claimed in claim 1, wherein when the assessment group is the incorrect group, the method comprises:
determining similarity between one or more model data points within the set of model clusters and one or more test data points within the set of test set clusters; and
assigning the similarity value indicative of a zero value to the incorrect group, such that the incorrect group indicates that the one or more model data points are different from the one or more test data points, wherein a number of different one or more model data points is more than a number of matching one or more model data points.

7. The method as claimed in claim 1, wherein the set of model clusters generated includes an unlabeled dataset.

8. The method as claimed in claim 1, wherein the unsupervised clustering ML model includes at least one of K-Means Clustering, Hierarchical Clustering, Density-Based Spatial Clustering of Applications with Noise (DBSCAN), or Mean Shift.

9. The method as claimed in claim 1, wherein prior to generating the set of model clusters via the unsupervised clustering ML model, the method comprises:
assigning a set of hyperparameters corresponding to the unsupervised clustering ML model for generating the set of model clusters such that the total similarity value corresponds to the assigned set of hyperparameters; and
selecting the set of hyperparameters based on comparing the total similarity value and a pre-defined threshold.

10. A system for evaluating an unsupervised clustering machine learning (ML) model, the system comprising:
a memory;
at least one processor in communication with the memory, wherein the at least one processor is configured to:
generate a set of model clusters via the unsupervised clustering ML model;
compare a set of test set clusters and the set of model clusters;
categorize each of the set of model clusters into an assessment group based on the comparison, wherein the categorized assessment group is at least one of a match group, a correct group, a partial group, and an incorrect group;
assign a similarity value to each of the set of model clusters based on the categorized assessment group; and
determine a total similarity value based on combining the assigned similarity value of each of the set of model clusters, such that the total similarity value indicates evaluation of the unsupervised clustering ML model.

11. The system as claimed in claim 10, wherein when the assessment group is the match group, the at least one processor is configured to:
determine similarity between one or more model data points within the set of model clusters and one or more test data points within the set of test set clusters; and
assign the similarity value indicative of a non-zero integer to the match group, such that the match group indicates that each of the one or more model data points completely matches the one or more test data points.

12. The system as claimed in claim 10, wherein when the assessment group is the correct group, the at least one processor is configured to:
determine similarity between one or more model data points within the set of model clusters and one or more test data points within the set of test set clusters; and
assign the similarity value indicative of a penalized value to the correct group, such that the correct group indicates that the one or more model data points completely match the one or more test data points and the one or more model data points include at least one additional model data point different from the one or more test data points.

13. The system as claimed in claim 10, wherein the penalized value indicates a sigmoid function which is scaled based on a number of one or more test data points.

14. The system as claimed in claim 10, wherein when the assessment group is the partial group, the at least one processor is configured to:
determine similarity between one or more model data points within the set of model clusters and one or more test data points within the set of test set clusters; and
assign the similarity value indicative of a non-zero integer to the partial group, such that the partial group indicates that a portion of the one or more model data points completely matches the one or more test data points and has at least one additional model data point different from the one or more test data points.

15. The system as claimed in claim 10, wherein when the assessment group is the incorrect group, the at least one processor is configured to:
determine similarity between one or more model data points within the set of model clusters and one or more test data points within the set of test set clusters; and
assign the similarity value indicative of a zero value to the incorrect group, such that the incorrect group indicates that the one or more model data points are different from the one or more test data points, wherein a number of different one or more model data points is more than a number of matching one or more model data points.

16. The system as claimed in claim 10, wherein the set of model clusters generated includes an unlabeled dataset.

17. The system as claimed in claim 10, wherein the unsupervised clustering ML model includes at least one of K-Means Clustering, Hierarchical Clustering, Density-Based Spatial Clustering of Applications with Noise (DBSCAN), or Mean Shift.

18. The system as claimed in claim 10, wherein prior to generating the set of model clusters via the unsupervised clustering ML model, the at least one processor is configured to:
assign a set of hyperparameters corresponding to the unsupervised clustering ML model for generating the set of model clusters such that the total similarity value corresponds to the assigned set of hyperparameters; and
select the set of hyperparameters based on comparing the total similarity value and a pre-defined threshold.
